(19) United States
(12) Patent Application Publication
(10) Pub. No.: US 2020/0065401 A1
(43) Pub. Date: Feb. 27, 2020

(54) USER-SPECIFIC DYNAMIC CONTEXT FOLDERS

(71) Applicant: SAP SE, Walldorf (DE)

(72) Inventor: Shiney Sooraj, Bangalore (IN)

(21) Appl. No.: 16/113,230

(22) Filed: Aug. 27, 2018

(51) Int. Cl. G06F 17/30

(52) U.S. Cl. CPC G06F 17/30106; G06F 17/30203; G06F 17/30112; G06F 17/30094

(57) ABSTRACT

A content file data store may contain a plurality of electronic content files (e.g., word processing, spreadsheet, and image files). A document server may receive, from a user via a remote user device, an indication of a particular context (e.g., a context name) to be created and create a first dynamic context folder. Information about the first dynamic context folder, including the indication of the particular context, may be stored into a dynamic context data store. The document server may then arrange for the first dynamic context folder to be active as the user's current context and detect that the user accesses a first electronic content file store (e.g., by opening or viewing the file). Responsive to the detection, the first electronic content file may be automatically associated with the first dynamic context folder, and a set of electronic content files associated with the first dynamic context folder may be displayed to the user.

### FIELD

Some embodiments are associated with ways to access information via a document server. In particular, some embodiments provide user-specific dynamic context folders for content.

### BACKGROUND

In some cases, a user might want to access information stored on a disk drive, a server, a database, etc. For example, a manager might want to retrieve business information about an enterprise from a database. Typically, users access many different files and different types of files during the day as they work on one or more projects, such as emails, word processing documents, spreadsheets, presentations, etc. Note that most of this content may be stored in different storage locations. For example, emails might be stored in a mail server, spreadsheets might be stored on a user's laptop, presentations might be stored in a shared folder, etc. As human beings, users generally think about information in a “context.” For example, if a user is working on a “Deal for Customer A,” then he or she might want to access all the relevant documents/content for this task in an accurate and efficient way. Users don't want to search laptops for a draft version of a deal proposal, search through emails for the last communication from Customer A, access shared folder for Customer A and look for a roadmap slide relevant to the deal, etc.

To achieve this result, a user might manually copy or move associated information into a single directory or folder. Such an approach, however, can be a time-consuming and error prone task—especially when there is a substantial amount of content stored in many different locations. Moreover, folders simply act as an encapsulation or wrapper of content that is placed into them and tend to get cluttered over time with content associated with many different contexts. In some cases, “smart folders” may be linked to queries such that the context of a folder keeps changing. For example: a smart folder for “My Video” files may automatically list all video files regardless of where they are stored. These folders are virtual but are not linked to a particular “context.” In another approach, virtual folder browsing may let groups of users manually define and save unique paths to sets of content. After using facets to manually define a dynamic view, virtual folders may let users save this “filtered view” and provide a simple to browse sets of related information regardless of its physical location. In this approach, however, now information is not automatically mapped to an appropriate virtual folder or context.

It may therefore be desirable to provide systems and methods to facilitate content access via a document server in an automated and logical manner.

### SUMMARY OF THE INVENTION

According to some embodiments, systems, methods, apparatus, computer program code and means are provided to facilitate content access via a document server in an automated and logical manner. In some embodiments, a content file data store may contain a plurality of electronic content files (e.g., word processing, spreadsheet, and image files). A document server may receive, from a user via a remote user device, an indication of a particular context (e.g., a context name) to be created and create a first dynamic context folder. Information about the first dynamic context folder, including the indication of the particular context, may be stored into a dynamic context data store. The document server may then arrange for the first dynamic context folder to be active as the user's current context and detect that the user accesses a first electronic content file store (e.g., by opening or viewing the file). Responsive to the detection, the first electronic content file may be automatically associated with the first dynamic context folder, and a set of electronic content files associated with the first dynamic context folder may be displayed to the user.

Some embodiments comprise: means for receiving, at a document server from a user via a remote user device, an indication of a particular context to be created; means for creating a first dynamic context folder associated with the indication of the particular context; means for storing information about the first dynamic context folder, including the indication of the particular context, into a dynamic context data store; means for arranging for the first dynamic context folder to be active as the user's current context; means for detecting that the user accesses a first electronic content file in the content file data store; means for responsive to the detection, automatically associating the first electronic content file with the first dynamic context folder; and means for arranging to display indications of a set of electronic content files associated with the first dynamic context folder, including the first electronic content file, to the user via the remote user device.

In some embodiments, a communication device associated with a document server exchanges information with remote user devices (e.g., a user who is accessing content, such as electronic files). The information may be exchanged, for example, via public and/or proprietary communication networks.

Technical effects of some embodiments of the invention are improved and computerized ways to facilitate content access via a document server in an automated and logical manner. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is a block diagram of a system according to some embodiments.

FIG. 2 illustrates method in accordance with some embodiments.

FIG. 3 is a method of creating a new context according to some embodiments.

FIG. 4 is an enterprise document center display in accordance with some embodiments.

FIG. 5 is a dynamic context folder display according to some embodiments.

FIG. 6 illustrates context creation in accordance with some embodiments.

FIG. 7 is a dynamic context folder display after the context is created according to some embodiments.

FIG. 8 is a more detailed method in accordance with some embodiments.

FIG. 9 illustrates a user accessing a spreadsheet file according to some embodiments.

FIG. 10 illustrates a user accessing a PDF file according to some embodiments.

FIG. 11 illustrates a user accessing an image file in accordance with some embodiments.

FIG. 12 is a dynamic context folder display after the user accessed the files of FIG. 9 through 11 according to some embodiments.

FIG. 13 illustrates a dynamic context folder plugin for an email application in accordance with some embodiments.

FIG. 14 illustrates an updated file menu according to some embodiments.

FIG. 15 is a technical flow diagram illustrating dynamic context creation and content access in accordance with some embodiments.

FIG. 16 is a technical flow diagram illustrating context fetching and file deletion according to some embodiments.

FIG. 17 is a technical flow diagram illustrating downloading and sharing a document in accordance with some embodiments.

FIG. 18 is a high-level diagram of an apparatus or platform in accordance with some embodiments.

FIG. 19 is a portion of a dynamic context folder database according to some embodiments.

FIG. 20 illustrates a handheld tablet computer in accordance with some embodiments.

### DETAILED DESCRIPTION

The following description is provided to enable any person in the art to make and use the described embodiments and sets forth the best mode contemplated for carrying out some embodiments. Various modifications, however, will remain readily apparent to those in the art.

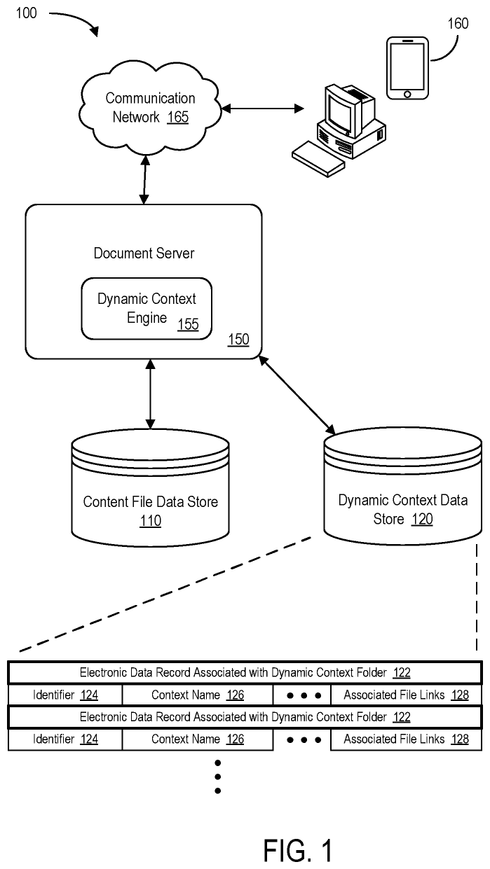

FIG. 1 is block diagram of a system 100 according to some embodiments of the present invention. In particular, the system 100 includes a user device 160 that may be used, for example, to access information in a content file data store 110 (e.g., creating a document, opening a document, saving a document, etc. via a user interface) via a communication network 165. According to some embodiments, information (e.g., files, folders, emails, etc.) may be associated with a particular “context.” As used herein, the term “context” may refer to any way that a user might categorize or group information. For example, the context might be associated with circumstances that form the setting for content, such as a work of phrase that helps the information be better understood and assessed. Example of context include environments, projects, conditions, factors, states, situations, background information, settings, frames of reference or other relationships, subjects, themes, topics, etc. In general, the context may shed light on content meaning or the user. A document server 150 and dynamic content engine 150 may access a dynamic content data store 120 (e.g., containing electronic records) to record and present information exchanged via the user devices 160. According to some embodiments, the dynamic context data store 120 contains electronic data records associated with dynamic context folders 122, including identifiers 124, context names 126, associated file likes 128, etc. The document server 150 might be, for example, associated with a Personal Computers (“PC”), laptop computer, an enterprise server, a server farm, and/or a database or similar storage devices.

As used herein, devices, including those associated with the document server 150 and any other device described herein, may exchange information via any communication network which may be one or more of a telephone network, a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

According to some embodiments, an “automated” document server 150 may facilitate the use of dynamic context folders. As used herein, the term “automated” may refer to, for example, actions that can be performed with little or no human intervention.

The document server 150 may store information into and/or retrieve information from the data stores 110, 120. The data stores 110, 120 may be a locally stored relational database or reside remote from the document server 150. The term “relational” may refer to, for example, a collection of data items organized as a set of formally described tables from which data can be accessed. Moreover, a Relational Database Management System (“RDBMS”) may be used in connection with any of the database tables described herein. According to some embodiments, a graphical administrator interface may provide an ability to access and/or modify elements of the system. The administrator interface might, for example, let an operator map users to context groups, apply rules and logic to context folder settings, etc.

Although a single document server 150 is shown in FIG. 1, any number of such devices may be included. Moreover, various devices described herein might be combined according to embodiments of the present invention. For example, in some embodiments, the document server 150 and dynamic context engine 155 might be co-located and/or may comprise a single apparatus. Moreover, the functions described herein might be implemented in a cloud computing environment and/or by a service provider (e.g., performing services for one or more enterprises, departments, or businesses).

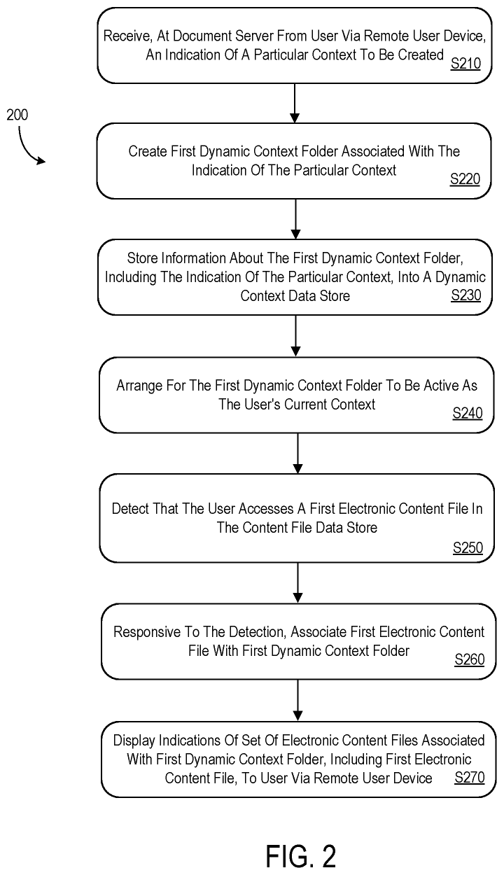

FIG. 2 illustrates a method 200 that might be performed by some or all of the elements of the system 100 described with respect to FIG. 1, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, a document server may receive, from a user via a remote user device, an indication of a particular context to be created. For example, the user might provide an alphanumeric name to be used for a new context. According to some embodiments, the receipt of the indication comprises receiving from the user an indication of acceptance of one or more automatically suggested alphanumeric names generated by the document server (e.g., based on a file name, directory name, meta-data, previous names created by that user or other users, etc.). Note that indications may be received from a user in any of a number of different ways. For example, a user might provide an indication via a keyboard, touchscreen, audio command (e.g., a user might say “create context ABC” or “select context “XYZ”), etc. At S220, a first dynamic context folder associated with the indication of the particular context may be created. At S230, the system may store information about the first dynamic context folder, including the indication of the particular context, into a dynamic context data store.

At S240, the system may arrange for the first dynamic context folder to be active as the user's current context. The folder might be automatically active when it is created, or a user might select the folder to be active. At S250, the system may detect that the user accesses a first electronic content file in the content file data store. The first electronic content file might be associated with, for example, a word processing document, a spreadsheet application, a portable document format file, an image file, an email, a video, a web page, etc. The detection that the user is accessing the first electronic content file may be associated with various types of user activities. For example, the system may detect when the user creates the first electronic content file, opens the file, saves the file, searches for the file, shares the file (e.g., with another user), views the file (e.g., a preview of the file without opening it), attaches the first electronic content file to an email message, etc. Responsive to the detection, at S260 the first electronic content file may be automatically associated with the first dynamic context folder. Note that a single file might be associated with more than one context. For example, a single graphics file might be associated with both a “Restaurant Menu” context folder and a “Due in September” context folder. At S270, the system may arrange to display indications of a set of electronic content files associated with the first dynamic context folder, including the first electronic content file, to the user via the remote user device.

According to some embodiments, the system may also receive, from the user via the remote user device, a selection of a new dynamic context folder to be active as the user's current context. The system may then retrieve, from the dynamic context data store, information about the new dynamic context folder, and arrange to display indications of a set of electronic content files associated with the new dynamic context folder to the user via the remote user device.

According to some embodiments, the system may receive, from the user via the remote user device, an indication that the particular context should be deleted and remove, from the dynamic context data store, information about the particular dynamic context folder. In some embodiments, the system may receive, from the user via the remote user device, an indication that the first electronic content file should no longer be associated with the particular context (e.g., the user might make a different context associated with that file, decide that no context should be associated with that file, etc.). In such cases, the system may remove, from the dynamic context data store, information about the first electronic content file's association with the particular dynamic context folder.

Thus, embodiments may provide context folders abs enable the automatic addition of content (including files of any type, such as spreadsheets, word processing documents, presentations, pictures, etc.) to a virtual folder that is bound to a user-defined context. All of the files that have been accessed, modified, uploaded, shared, etc. by the end-user within the current context may be automatically added to the current context folder. In this way, context may be bound to the document for the user. Moreover, all files that were accessed within that context are automatically added to the context folder which might be saved, for example, under “My Contexts.” In this way, the user may easily review all files saved to a given context by navigating to the appropriate context under “My Context.” This might be achieved, for example, by creating a custom property of files named AccessContext and populating it with a comma separated list of contexts to which the given file belongs.

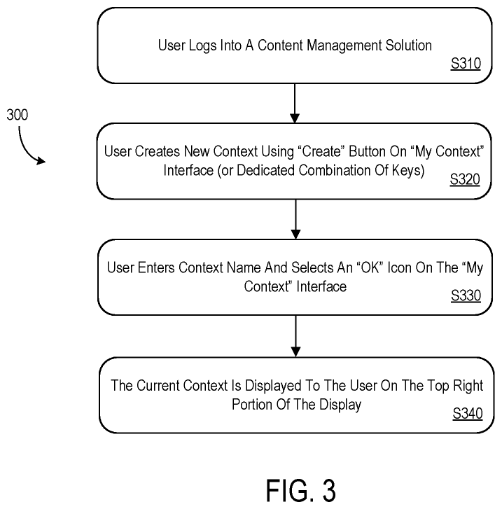

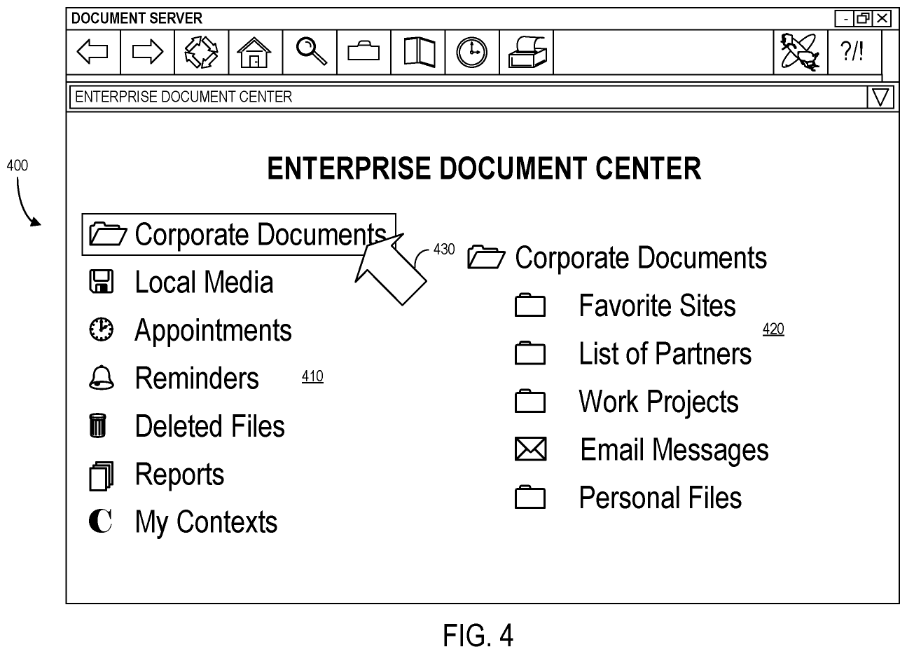

FIG. 3 is a method 300 of creating a new context according to some embodiments. At S310, a user may log into a content management solution (e.g., associated with an enterprise's document server). At S320, the user may create a new context using a “Create” icon on a My Contexts interface. According to some embodiments, a simultaneous combination of keyboard buttons (e.g., “Cntl”+“Alt”+“C”) might be used to invoke this feature. At S330, the user enters a context name (e.g., “Seattle Travel Plans”) and selects an “OK” icon on the My Contexts interface. At S340, the current context is displayed to the user on a top right portion of the display. For example, FIG. 4 is an enterprise document center display 400 in accordance with some embodiments. The display 400 includes a first area 410 listing folders or types of documents or locations (e.g., associated with corporate documents, removable media, appointments, reminders, deleted files, reports, My Contexts, etc.). Selection of one of the elements in the first area 410 results in a display of items within that element in a second area 420 (e.g., when the corporate documents element is selected in the first area 410 via a touchscreen or computer mouse pointer 430—a list of items in that element is displayed in the second area 420).

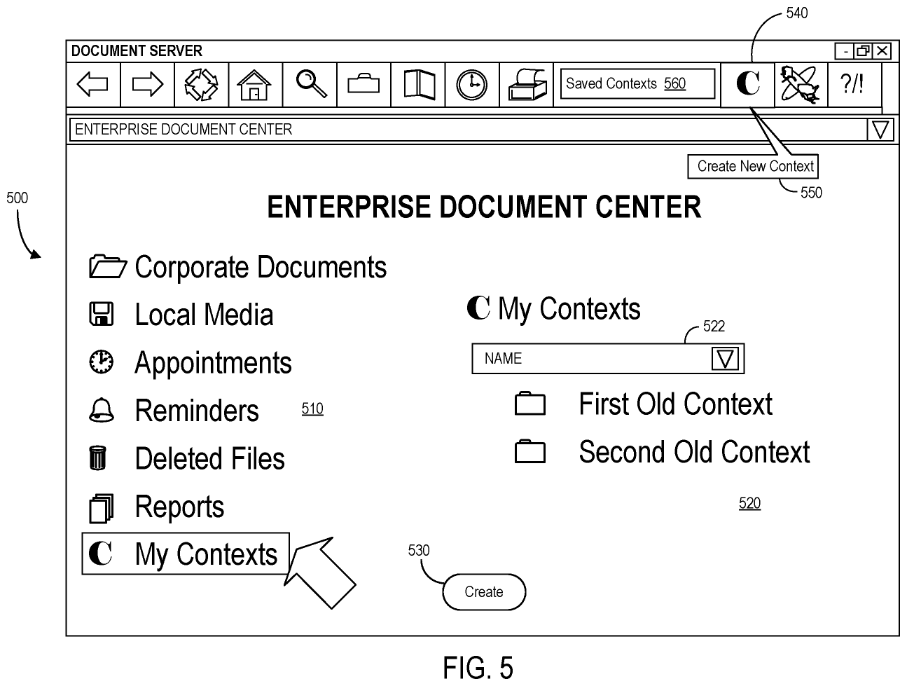

When the “My Contexts” element is selected in the first area 410, a “My Contexts” display may be provided in the second area 420. For example, FIG. 5 is a dynamic context folder display 500 according to some embodiments. When the user selected “My Contexts” in the first area 510, a My Contexts display is provided in the second area 520 showing that two different contexts currently exist (“First Old Context” and “Second Old Context”). According to some embodiments, the user may also enter or select a search term 522 to find a particular context. In addition to selecting an existing context, the user might select a “Create” icon 530 to establish a brand-new context. According to some embodiments, a context icon 540 in the browser toolbar may also have a selectable portion 550 that can be used to create a new context. A text search area 560 may also be provided to let a user look for a pre-existing context.

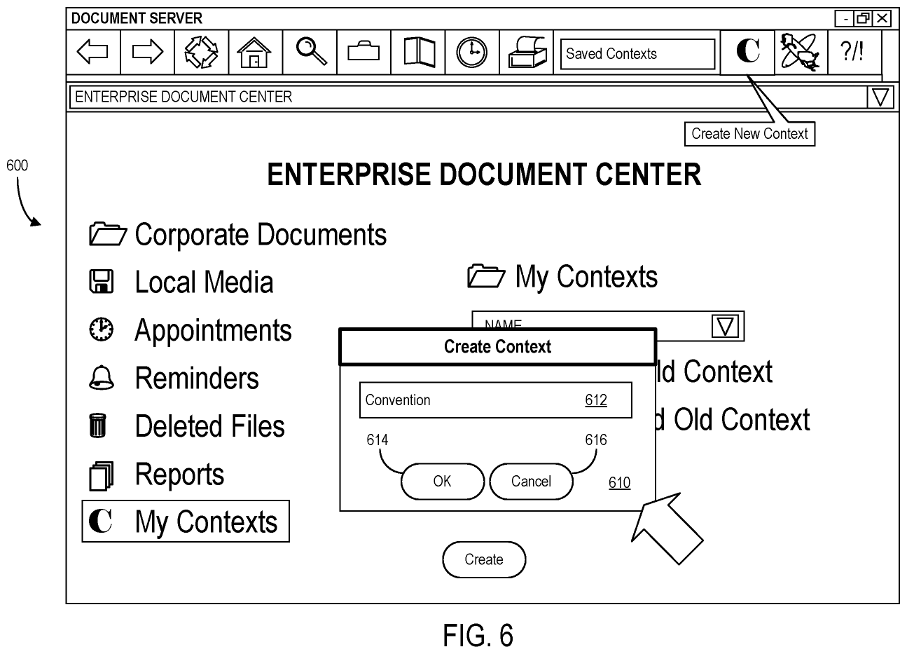

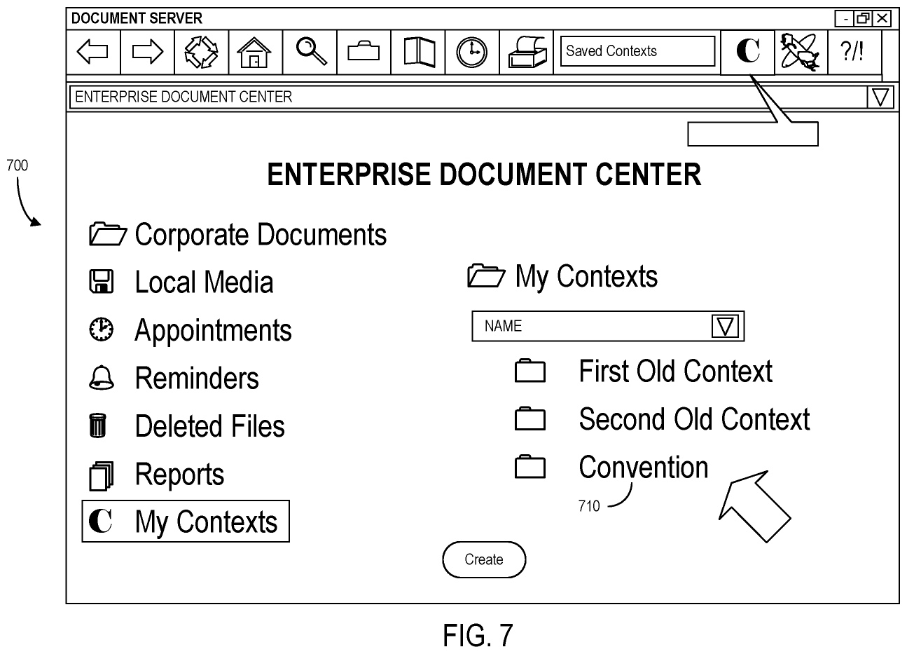

Selection of the “Create” icon 530 or selectable portion 550 may let the user enter a new name for the new context. For example, FIG. 6 illustrates context creation in accordance with some embodiments. In particular, a display 600 includes a popup window 610 named “Create Context” that can be used to enter a name 612 for the new context. For example, selection of an “OK” icon 614 may result in a dynamic context folder being created with that name (while selection of a “Cancel” icon 616 may abort the process without creating a new dynamic context folder). FIG. 7 is a dynamic context folder display 700 after the “Convention” context was created according to some embodiments. In particular, the display 700 includes an indication of the “Convention” name 720 that was created. In some cases, the new “Convention” context will automatically be selected as the currently active dynamic context folder. In other cases, the user would need to actively select “Convention” to make it active.

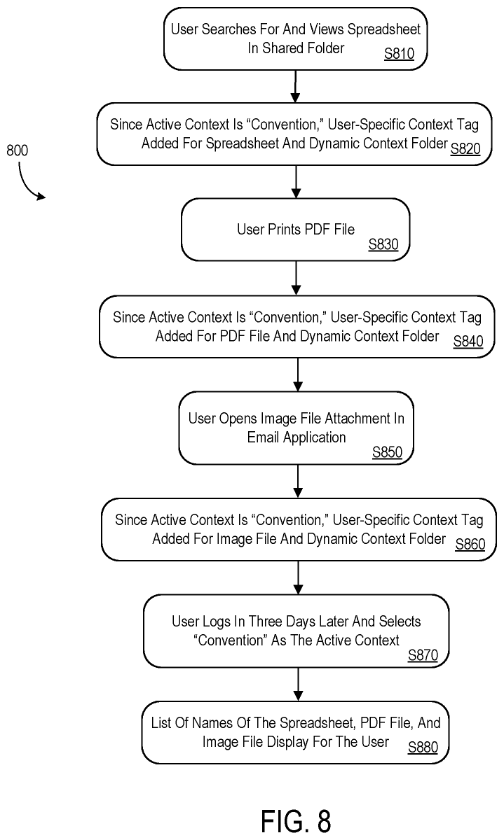

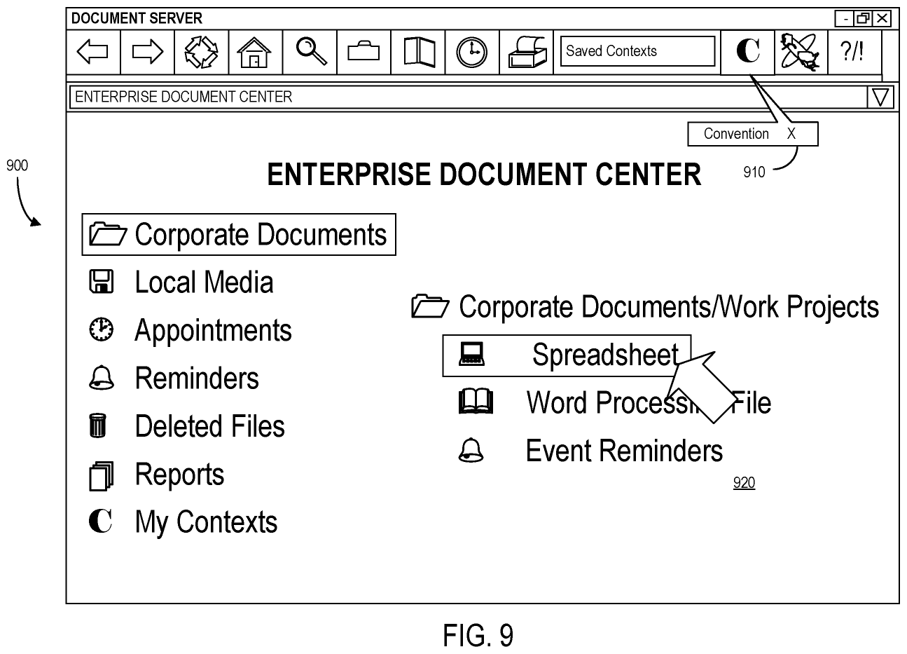

FIG. 8 is a more detailed method 800 in accordance with some embodiments. At S810, a user at a workplace may search for and view a particular spreadsheet in a shared folder. Assume for this example that a context named “Convention” is the currently active context for the user. Because the “Convention” context is active, a user specific tag is created linking that dynamic context folder and the spreadsheet at S820. For example, FIG. 9 illustrates a user accessing a spreadsheet file according to some embodiments. As shown by portion 910 of the context icon in the toolbar, “Convention” is the currently active dynamic context folder. Note that selection of the “X” in the portion might remove “Convention” as the currently active dynamic context folder (that is, there would be no currently active context). The spreadsheet is selected in the list 920 on the right side of the display 900.

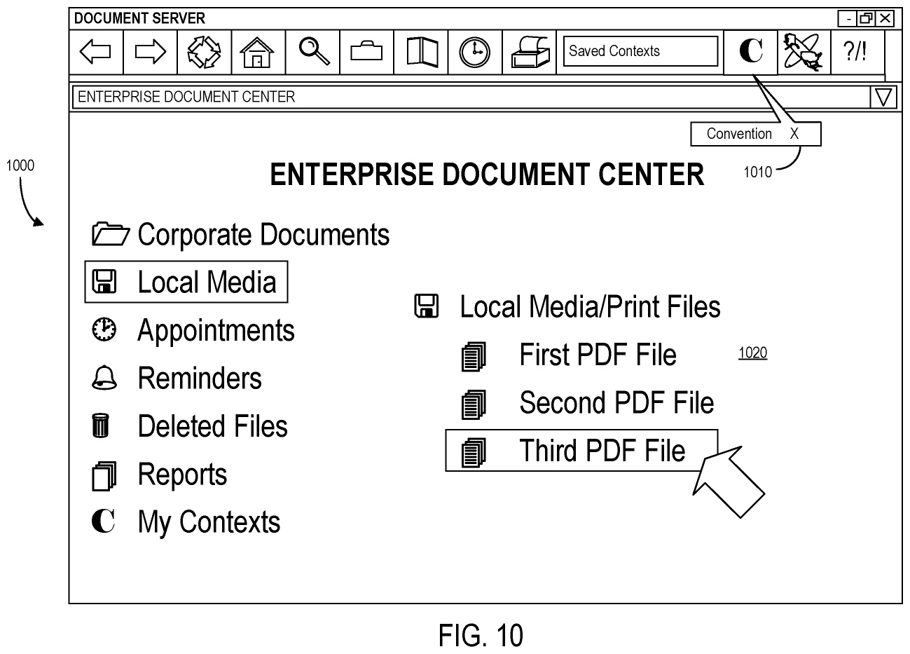

Referring again to FIG. 8, at S830 the user prints a Portable Document Format (“PDF”) file (e.g., the user might be viewing a web page containing a convention schedule and “print” that web page to a PDF file that is locally stored on his or her laptop). Because the “Convention” context is active, a user specific tag is created linking that dynamic context folder and the PDF file at S840. For example, FIG. 10 illustrates a user accessing a Portable Document Format (“PDF”) file according to some embodiments. As shown by portion 1010 of the context icon in the toolbar, “Convention” is the currently active dynamic context folder. The third PDF file is selected in the list 1020 on the right side of the display 1000.

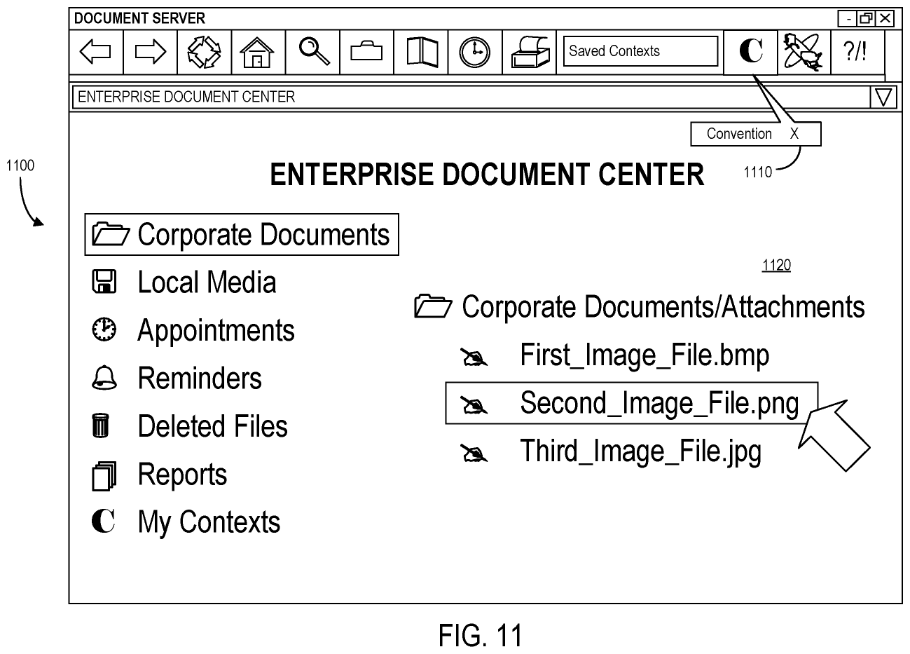

Referring again to FIG. 8, at S850 the user opens an image file attachment in an email application. Because the “Convention” context is active, a user specific tag is created linking that dynamic context folder and the image file attachment at S860. According to some embodiments, the email itself might also be linked to the dynamic context folder. The user may then log off and go home. For example, FIG. 11 illustrates a user accessing an image file in accordance with some embodiments. As shown by portion 1110 of the context icon in the toolbar, “Convention” is the currently active dynamic context folder. The second image is selected in the list 1120 on the right side of the display 1100.

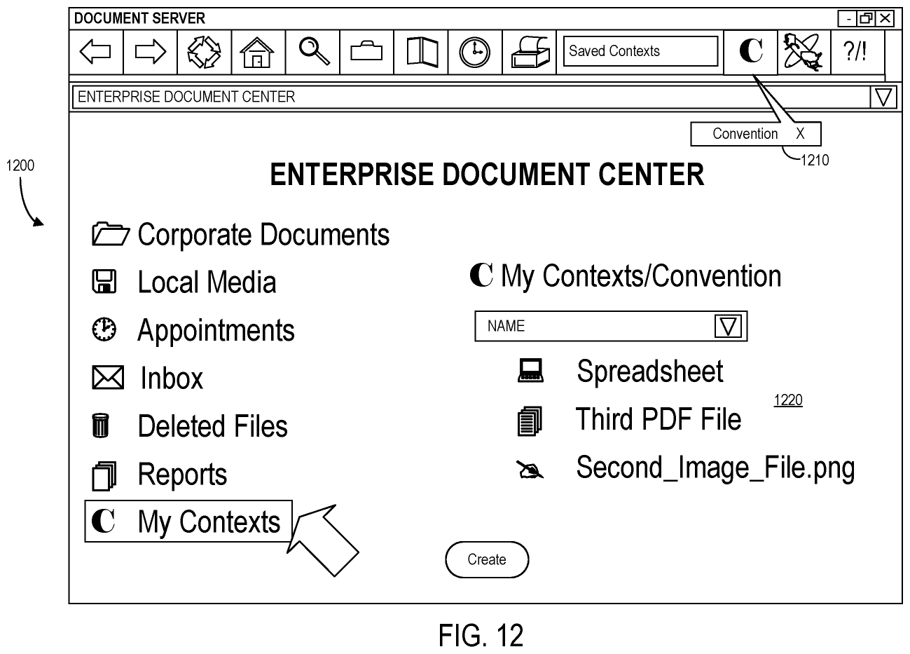

Referring again to FIG. 8, at S870 the user returns to work three days later and again selects “Convention” as the active context. At S880, a list of names including the spreadsheet, PDF file, and image file automatically displayed to the user. In this way, he or she can easily and automatically access all content related to that subject matter. For example, FIG. 12 is a dynamic context folder display 1200 after the user accessed the files of FIG. 9 through 11 according to some embodiments. Because “Convention” is the current context 1210, the displayed list 1220 includes the spreadsheet (selected in FIG. 9), the third PDF file (selected in FIG. 10), and the second image file (selected in FIG. 11).

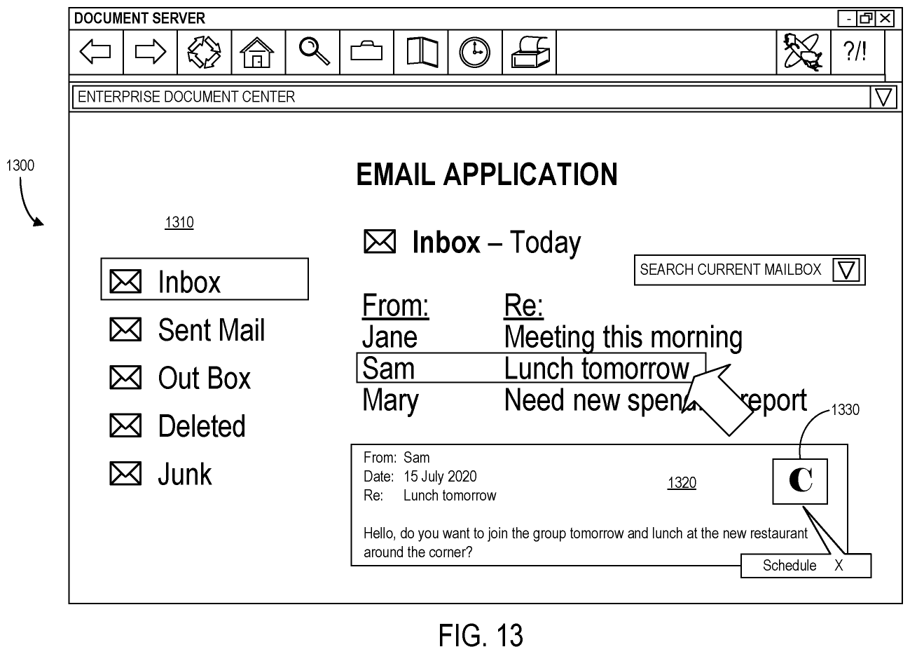

Some embodiments may apply dynamic context folders in connection with an email application plugin. For example, FIG. 13 illustrates a dynamic context folder plugin for an email application 1300 in accordance with some embodiments. In this example, a user may select a mailbox 1310 to access an individual email message 1320 within that mailbox 1310. The message 1320 includes a context icon 1330 that can be selected to add that message 1320 to the appropriate dynamic context folder. According to other embodiments, the icon 1330 might be incorporated within the toolbar at the top of the display in addition to, or instead of, the email message 1320 itself. That a newly created email might automatically be added to the currently active context. Printing an email, selecting an attachment, etc. might be handled in a similar fashion. In this way, the solution can be extended to add most commonly accessed context—emails to a Context folder via a Mail Server plugin.

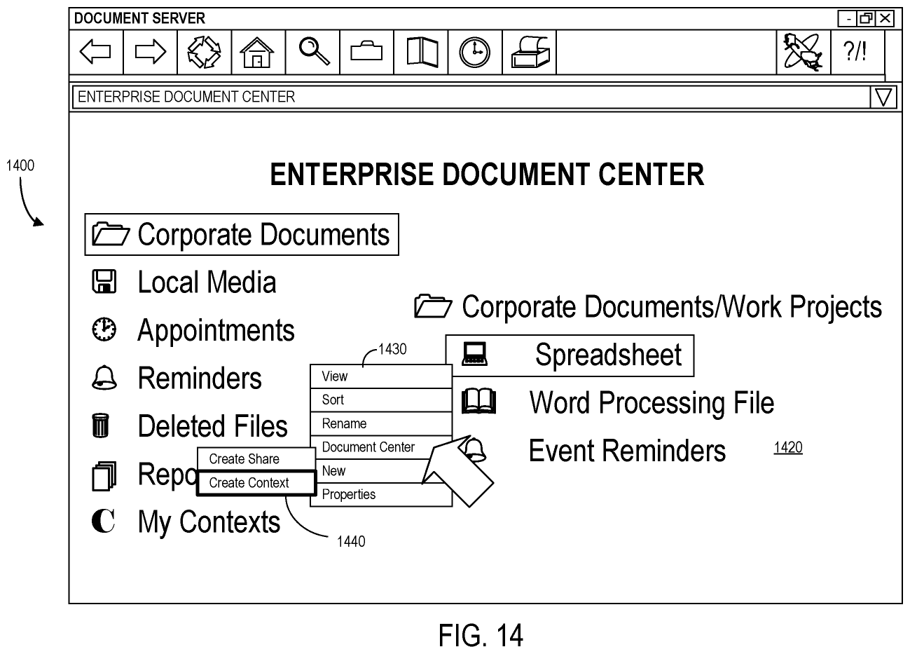

According to some embodiments, a portion of the document server executes in a cloud-based environment and a portion of the document server executes offline at the remote user device. The document server may then automatically synchronize user inputs via the cloud-based portion of the document server and user inputs via the offline portion of the document server. FIG. 14 illustrates a display 1400 an updated file menu according to some embodiments. When a document is selected via the right-side portion 1420 of the display, a menu 1430 may appear with a “Document Center” icon option. Selection of that icon can be used to access a sub-menu with a “Create Context” selection that allows a new context to be established or selected. In this way, the solution can be extended to work in an offline mode, where the user can create/access context folders when offline. Any updates made to the context folders may be automatically synchronized with the server when the user is back online. For example, all files accessed by the end user offline may be tracked and added to a locally maintained current context folder. The context folder may be synchronized with the server when the online connection is re-established. As a result, the offline desktop client application can be extended to enable the end-user to create/access dynamic context folders.

According to some embodiments, a dynamic context folder may be associated with a Content Management Interface (“CMI”) interoperability guideline protocol. Note that technical custom attributes for each file may be defined to be bound to a context. According to some embodiments, an AccessContext property of a file may consist of a Context Globally Unique Identifier (“GUID”) to identify a user's context. If a file is accessed in multiple contexts, the AccessContext property may utilize a comma separated list of all associated context GUIDs as a value. According to some embodiments, the AccessContext property may be updated whenever a file is accessed, viewed, shared, downloaded, etc. while a given context is “ON” or “active.” When a file is deleted/removed from a context, the AccessContext property may be updated to remove the reference of the Context GUID from which it was deleted. By way of example, the custom property name “AccessContext” might be associated with the following:
Property Type: “String,”
Inherited: “FALSE,”
Required: “FALSE,”
Cardinality: “multi,”
Updatability: should be “READWRITE,”
Choices: “not applicable,”
Open Choice: “not applicable,”
Query-able: should be “TRUE,” and
Orderable: should be “TRUE.”

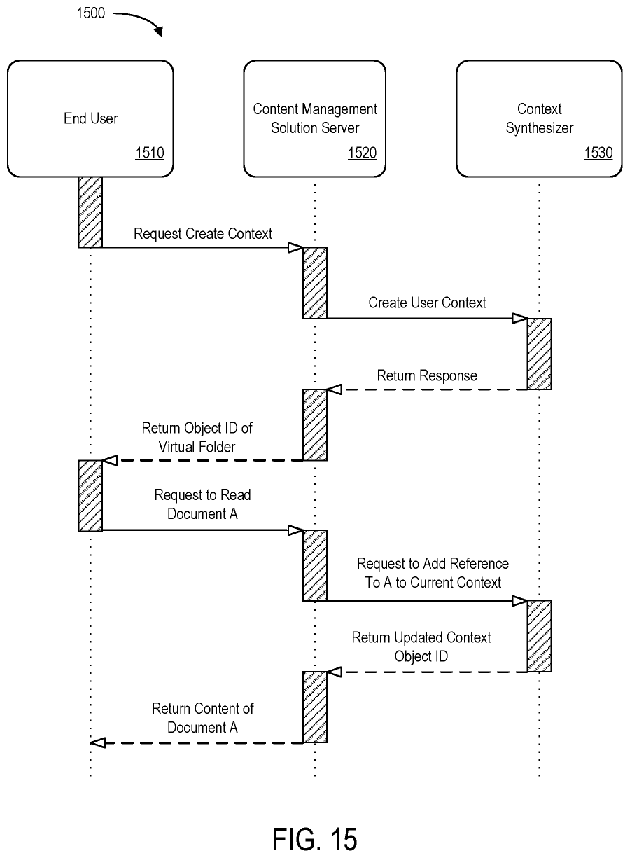

FIG. 15 is a technical flow diagram 1500 illustrating dynamic context creation and content access in accordance with some embodiments. Initially, an end user 1510 transmits a request to create a context to a content management solution server 1520. The content management solution server 1520 send a signal to create a new user context to a context synthesizer 1530 which returns a response to the content management solution server 1520. The content management solution server 1520 may then send an object identifier of the virtual folder to the end user 1510. The end user 1510 may then transmit request to read document A to a content management solution server 1520. The content management solution server 1520 transmits a request to add a reference to document A to the current context to the context synthesizer 1530 which returns an updated context object identifier to the content management solution server 1520. The content management solution server 1520 may then send the content of document A to the end user 1510.

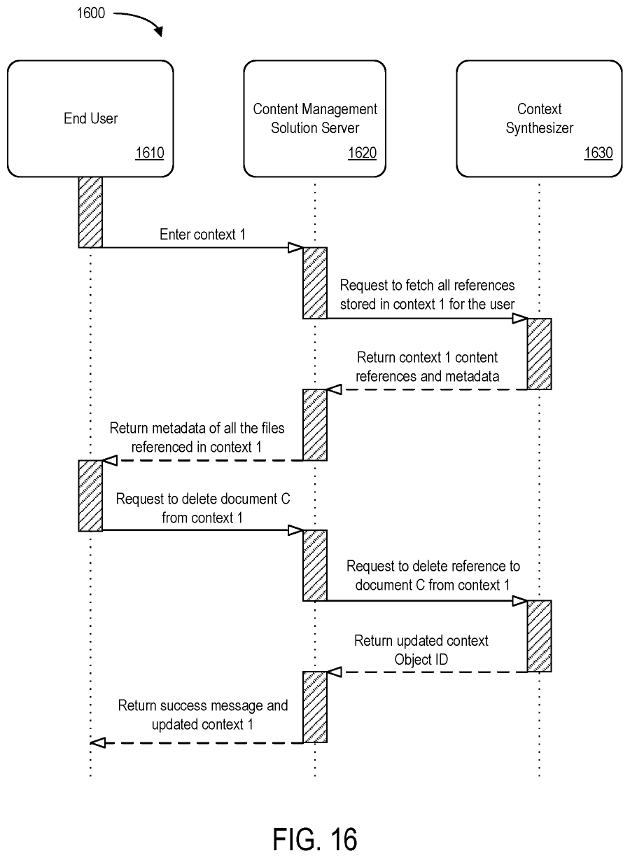

FIG. 16 is a technical flow diagram 1600 illustrating context fetching and file deletion according to some embodiments. The flow begins when an end user 1610 selects a currently active dynamic context folder (“context 1”) to a content management solution server 1620. The content management solution server 1620 sends request to fetch all references stored in context 1 to the current context to a context synthesizer 1630 which returns context 1 content references and metadata to the content management solution server 1620. The content management solution server 1620 may then return the metadata of all the files referenced in context 1 to the end user 1610. When the user wants to delete content from a context (e.g., by selecting the “X” icon), a request to delete document C from context 1 may be transmitted from the end user 1610 to the content management solution server 1620. The content management solution server 1620 transmits a request to delete the reference to document C from context 1 to the context synthesizer 1630 which returns an updated context Object ID (without document C) to the content management solution server 1620. The content management solution server 1620 may then send a success message and updated context 1 information to the end user 1610.

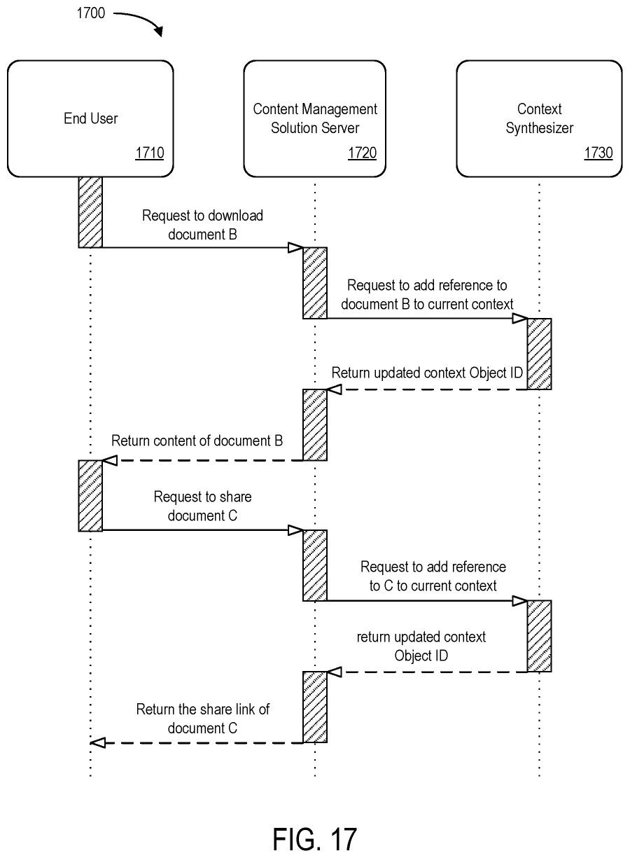

FIG. 17 is a technical flow diagram 1700 illustrating downloading and sharing a document in accordance with some embodiments. Initially, an end user 1710 transmits a request to download document B to a content management solution server 1720. The content management solution server 1720 transmits a request to add a reference to document B to the currently active context to a context synthesizer 1730 which returns an updated context object identifier to the content management solution server 1720. The content management solution server 1720 may then send the content of document B to the end user 1710. The end user 1710 may then transmit a request to share document C to the content management solution server 1720. The content management solution server 1720 transmits a request to add a reference to document C to the currently active context to the context synthesizer 1730 which returns an updated context object identifier to the content management solution server 1720. The content management solution server 1720 may then send the share link of document C to the end user 1710.

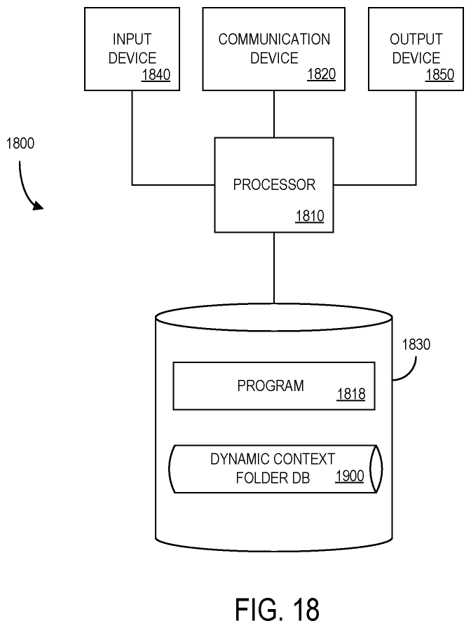

The embodiments described herein may be implemented using any of a number of different computer hardware implementations. FIG. 18 is a block diagram of apparatus 1800 according to some embodiments (e.g., associated with a document server and/or context management engine). The apparatus 1800 may comprise a general-purpose computing apparatus and may execute program code to perform any of the functions described herein. The apparatus 1800 may include other unshown elements according to some embodiments. According to some embodiments, the apparatus 1800 includes a processor 1810 operatively coupled to a communication device 1820, a data storage device 1830, one or more input devices 1840, one or more output devices 1850, and/or a memory 1860. The communication device 1820 may facilitate communication with external devices, such as a remote user device. The input device(s) 1840 may comprise, for example, a keyboard, a keypad, a mouse or other pointing device, a microphone, knob or a switch, an Infra-Red (“IR”) port, a docking station, and/or a touch screen. The input device(s) 1840 may be used, for example, to enter information into the apparatus 1800 (e.g., context management rules or logic, content mapping data, etc.). The output device(s) 1850 may comprise, for example, a display (e.g., a display screen) a speaker, and/or a printer (e.g., to provide context summary results to an administrator or operator, summary reports, troubleshooting information, etc.).

The data storage device 1830 may comprise any appropriate persistent storage device, including combinations of magnetic storage devices (e.g., magnetic tape, hard disk drives and flash memory), optical storage devices, Read Only Memory (“ROM”) devices, etc., while the memory 1860 may comprise Random Access Memory (“RAM”).

The program code 1832 may be executed by the processor 1810 to cause the apparatus 1800 to perform any one or more of the processes described herein. Embodiments are not limited to execution of these processes by a single apparatus. The data storage device 1830 may also store data and other program code for providing additional functionality and/or which are necessary for operation thereof, such as device drivers, Operating System (“OS”) files, etc. For example, the processor 1810 may access a plurality of electronic content files (e.g., word processing, spreadsheet, and image files). The processor 1820 may also receive, from a user via a remote user device, an indication of a particular context (e.g., a context name) to be created and create a first dynamic context folder. Information about the first dynamic context folder, including the indication of the particular context, may be stored by the processor into a dynamic context data store. The processor 1810 may then arrange for the first dynamic context folder to be active as the user's current context and detect that the user accesses a first electronic content file store (e.g., by opening or viewing the file). Responsive to the detection, the first electronic content file may be automatically associated with the first dynamic context folder by the processor 1810, and a set of electronic content files associated with the first dynamic context folder may be displayed to the user.

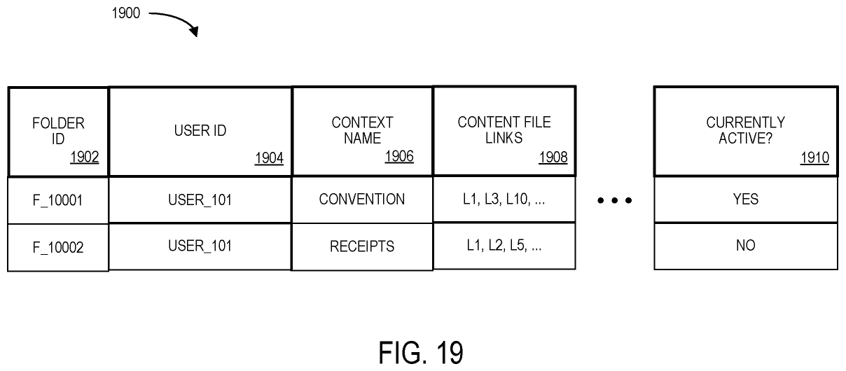

In some embodiments (such as shown in FIG. 18), the storage device 1830 further stores a dynamic context folder database 1900. An example of a database that may be used in connection with the apparatus 1800 will now be described in detail with respect to FIG. 19. Note that the database described herein is only one example, and additional and/or different information may be stored therein. Moreover, various databases might be split or combined in accordance with any of the embodiments described herein.

Referring to FIG. 19, a table is shown that represents the dynamic context folder database 1900 that may be stored at the apparatus 18100 according to some embodiments. The table may include, for example, entries identifying various contexts or areas of interest that a user would like to utilize to organize information. The table may also define fields 1902, 1904, 1906, 1908, 1910 for each of the entries. The fields 1902, 1904, 1906, 1908, 1910 may, according to some embodiments, specify: a folder identifier 1902, a user identifier 1904, a context name 1906, content file links 1908, and an indication of whether the folder is currently active 1910. The dynamic context folder database 1900 may be created and updated, for example, based on information received via remote user device.

The folder identifier 1902 may be, for example, a unique alphanumeric code identifying a virtual folder that a user will access to help him or her access information that is automatically organized. The user identifier 1904 may identify the specific user who created the folder (and whose actions may be used to automatically update the folder). The context name 1906 was provided by the user when he or she created the dynamic context folder. The content file links 1908 point to all of the content that has been accessed by the user while the context was active. That is, the virtual folder does not contain copies of these documents but instead a link or pointer to those documents. The indication of whether the folder is currently active 1910 may be used to determine if a future access of information by the user should result in the content file links being automatically updated.

Thus, embodiments may provide several advantages, such as allowing a user to access content mapped to a particular “context.” The accessed content may be automatically managed in folders named by the user so as to be context intuitive. Also, the end-user does not need to keep manually adding files to the context sensitive folders, because the files are automatically tagged and added whenever the user is working with documents within a given context. Because context folders only list files that are relevant for a context, the end-user may visualize all content relevant to a logical context in one folder.

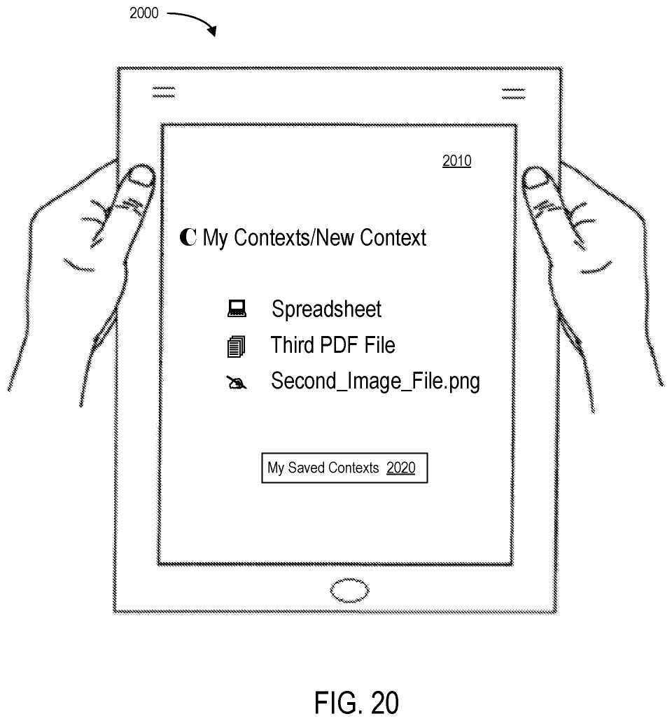

The foregoing diagrams represent logical architectures for describing processes according to some embodiments, and actual implementations may include more or different components arranged in other manners. Other topologies may be used in conjunction with other embodiments. Moreover, each system described herein may be implemented by any number of devices in communication via any number of other public and/or private networks. Two or more of such computing devices may be located remote from one another and may communicate with one another via any known manner of network(s) and/or a dedicated connection. Each device may comprise any number of hardware and/or software elements suitable to provide the functions described herein as well as any other functions. For example, any computing device used in an implementation of the discussed architectures may include a processor to execute program code such that the computing device operates as described herein. Moreover, the displays described are provided only as examples and other types of displays might be implemented. For example, FIG. 20 shows a handheld tablet computer 2000 in accordance with some embodiments. A display 2010 might provide information about dynamic context folders and one or more icons 2020 may be selected by the user to adjust operation of the system (e.g., by adding a new context, selecting a context to be active, etc.).

Embodiments have been described herein with respect to electronic stored content (e.g., opening a word processing file, a presentation, a spreadsheet, etc.). Note, however, that embodiments may also be associated with categorizing physical items in connection with a context. For example, each book in a library might be associated with a Quick Response (“QR”) code, bar code, image recognition, etc. and be added to a user's dynamic context folder (e.g., when he or she scans the code while working on a currently active research project). Similar, lab equipment, medical files, etc. may utilize embodiments described herein.

All systems and processes discussed herein may be embodied in program code stored on one or more non-transitory tangible computer-readable media. Such media may include, for example, a floppy disk, a CD-ROM, a DVD-ROM, a Flash drive, magnetic tape, and solid-state RAM or ROM storage units. Embodiments are therefore not limited to any specific combination of hardware and software.

Embodiments described herein are solely for the purpose of illustration. Those in the art will recognize other embodiments may be practiced with modifications and alterations to that described above.

What is claimed is:

1. A system associated with electronic content file access, comprising:
(a) a content file data store containing a plurality of electronic content files;
(b) a dynamic context data store; and
(c) a document server, coupled to the content file data store and the dynamic context folder data store, adapted to:
(i) receive from a remote user device, associated with a user, an indication of a particular context to be created via a distributed communication network,
(ii) create a first dynamic context folder associated with the indication of the particular context,
(iii) store information about the first dynamic context folder, including the indication of the particular context, into the dynamic context data store,
(iv) arrange for the first dynamic context folder to be active as the user's current context,
(v) detect that the user accesses a first electronic content file in the content file data store,
(vi) responsive to the detection, automatically associate the first electronic content file with the first dynamic context folder, and
(vii) arrange to display indications of a set of electronic content files associated with the first dynamic context folder, including the first electronic content file, to the user via the remote user device.

2. The system of claim 1, wherein the first electronic content file is associated with at least one of: (i) a word processing document, (ii) a spreadsheet application, (iii) a portable document format file, (iv) an image file, (v) an email, (vi) a video, and (vii) a web page.

3. The system of claim 1, wherein the indication of the particular context comprises an alphanumeric name.

4. The system of claim 3, wherein receipt of the indication comprises receiving from the user an indication of acceptance of an automatically suggested alphanumeric name generated by the document server.

5. The system of claim 1, wherein the document server is further adapted to:
receive, from the user via the remote user device, a selection of a new dynamic context folder to be active as the user's current context,
retrieve, from the dynamic context data store, information about the new dynamic context folder, and
arrange to display indications of a set of electronic content files associated with the new dynamic context folder to the user via the remote user device.

6. The system of claim 1, wherein the detection that the user is accessing the first electronic content file is associated with at least one of: (i) opening the first electronic content file, (ii) creating the first electronic content file, (iii) saving the first electronic content file, (iv) searching for the first electronic content file, (v) sharing the first electronic content file, (vi) viewing the first electronic content file, and (vii) attaching the first electronic content file to an email message.

7. The system of claim 1, wherein the document server is further adapted to:
receive, from the user via the remote user device, an indication that the particular context should be deleted, and
remove, from the dynamic context data store, information about the particular dynamic context folder.

8. The system of claim 1, wherein the document server is further adapted to:
receive, from the user via the remote user device, an indication that the first electronic content file should no longer be associated with the particular context, and
remove, from the dynamic context data store, information about the first electronic content file's association with the particular dynamic context folder.

9. The system of claim 1, wherein a portion of the document server executes in a cloud-based environment and a portion of the document server executes offline at the remote user device.

10. The system of claim 9, wherein the document server is further adapted to automatically synchronize user inputs via a cloud-based portion of the document server and user inputs via the offline portion of the document server.

11. The system of claim 1, wherein the dynamic context folder is associated with a content management interface interoperability guideline protocol.

12. The system of claim 1, wherein at least a portion of the document server is associated with an email application plugin.

13. A computer-implemented method associated with electronic content file access, comprising:
receiving, at a document server from a user via a remote user device, an indication of a particular context to be created;
creating a first dynamic context folder associated with the indication of the particular context;
storing information about the first dynamic context folder, including the indication of the particular context, into a dynamic context data store;
arranging for the first dynamic context folder to be active as the user's current context;
detecting that the user accesses a first electronic content file in the content file data store;
responsive to the detection, automatically associating the first electronic content file with the first dynamic context folder; and
arranging to display indications of a set of electronic content files associated with the first dynamic context folder, including the first electronic content file, to the user via the remote user device.

14. The method of claim 13, wherein the first electronic content file is associated with at least one of: (i) a word processing document, (ii) a spreadsheet application, (iii) a portable document format file, (iv) an image file, (v) an email, (vi) a video, and (vii) a web page.

15. The method of claim 13, wherein the indication of the particular context comprises an alphanumeric name.

16. The method of claim 13, further comprising:
receiving, from the user via the remote user device, a selection of a new dynamic context folder to be active as the user's current context;
retrieving, from the dynamic context data store, information about the new dynamic context folder; and
arranging to display indications of a set of electronic content files associated with the new dynamic context folder to the user via the remote user device.

17. A non-transitory, computer-readable medium storing program code, the program code executable by a computer processor to cause the processor to perform a method associated with electronic content file access, the method comprising:
receiving, at a document server from a user via a remote user device, an indication of a particular context to be created;
creating a first dynamic context folder associated with the indication of the particular context;
storing information about the first dynamic context folder, including the indication of the particular context, into a dynamic context data store;
arranging for the first dynamic context folder to be active as the user's current context;
detecting that the user accesses a first electronic content file in the content file data store;
responsive to the detection, automatically associating the first electronic content file with the first dynamic context folder; and
arranging to display indications of a set of electronic content files associated with the first dynamic context folder, including the first electronic content file, to the user via the remote user device.

18. The medium of claim 17, wherein the detection that the user is accessing the first electronic content file is associated with at least one of: (i) opening the first electronic content file, (ii) creating the first electronic content file, (iii) saving the first electronic content file, (iv) searching for the first electronic content file, (v) sharing the first electronic content file, (vi) viewing the first electronic content file, and (vii) attaching the first electronic content file to an email message.

19. The medium of claim 17, wherein the method further comprises:
receiving, from the user via the remote user device, an indication that the particular context should be deleted; and
removing, from the dynamic context data store, information about the particular dynamic context folder.

20. The medium of claim 17, wherein the method further comprises:
receiving, from the user via the remote user device, an indication that the first electronic content file should no longer be associated with the particular context; and
removing, from the dynamic context data store, information about the first electronic content file's association with the particular dynamic context folder.
